(19) United States
(12) Patent Application Publication
(10) Pub. No.: US 2025/0196584 A1
(43) Pub. Date: Jun. 19, 2025

(54) HIGH VOLTAGE PUMP AND HEATER ASSEMBLY WITH SCAVENGE PATH

(71) Applicant: HORTON, INC., Roseville, MN (US)

(72) Inventors: Scott Miller, Edina, MN (US); Ryan Niederkorn, Hastings, MN (US); Robert D. Cayton, Blaine, MN (US)

(21) Appl. No.: 19/066,612

(22) Filed: Feb. 28, 2025

Related U.S. Application Data
(63) Continuation-in-part of application No. PCT/US2023/031739, filed on Aug. 31, 2023.
(60) Provisional application No. 63/374,333, filed on Sep. 1, 2022.

(51) Int. Cl. B60H 1/22; F04D 13/06; F24H 1/14; F24H 9/00; H05B 1/02

(52) U.S. Cl. CPC B60H 1/2218; B60H 1/2221; F04D 13/06; F24H 1/142; F24H 9/0015; H05B 1/0236; F24H 2250/02

(57) ABSTRACT

A pump and heater assembly can include an electric motor, a pump, one or more resistive heater elements, a control module with switching electronics usable to control operation of the electric motor, and a flowpath through which a coolant fluid is flowable fluidically passing to a first manifold downstream of the pump, to both first and second flowpath segments branching from the first manifold, and to a second manifold downstream of both the first and second flowpath segments. The first flowpath segment passes proximate to the heater elements to enable heating of a portion of the coolant fluid present in the first flowpath segment. The second flowpath segment passes through the control module proximate to the switching electronics to enable cooling of the switching electronics by a portion of the coolant fluid present in the second flowpath segment. The first and second flowpath segments can be arranged fluidically in parallel.

### CROSS-REFERENCE TO RELATED APPLICATIONS

The present application is a continuation-in-part of and claims priority of International patent application Serial No. PCT/US2023/031739, filed Aug. 31, 2023, and published in English, and further claims priority to U.S. provisional patent application Ser. No. 63/374,333, filed Sep. 1, 2022, the contents of each of which are hereby incorporated by reference in their entireties.

### FIELD

The present invention relates generally to high voltage electrically-powered fluid pumps and heater assemblies, as well as to components thereof and associated methods.

### BACKGROUND

The advent of zero-emission vehicles (ZEVs), such as battery electric-and fuel cell-powered vehicles (the latter considered a ZEV because fuel cells have no smog-related or greenhouse gas tailpipe emissions), has opened up the need to provide pre-conditioning for other on-board components such as energy storage devices, electronics, etc. and to provide a heat source for heating the cabin of such vehicles. Pre-conditioning helps with thermal management of on-board components, such as batteries, to help them to work at more optimal temperatures. Climate control heating, as part of heating, ventilation, and air conditioning (HVAC) systems, helps provide a comfortable on-board working environment for the operator, and any passengers, in a cabin and/or sleeper unit, as well as for cargo spaces (including in trailers or the like), when the ambient temperatures are low such as during winter months.

Vehicles and equipment that are powered by internal combustion engines are typically heated by using the waste heat of the engine to provide a heat source for conditioned air for the cabin and the like. However, when the internal combustion engine is eliminated in ZEVs and the like, the engine heat source is no longer present and a new source for providing heat for climate control and/or pre-conditioning must be used.

### SUMMARY

In one aspect, a pump and heater assembly can include an electric motor, a pump operatively connected to the electric motor, one or more heater elements each configured to generate heat through electrical resistance, plurality of heat exchange elements each having a primary heat transfer surface and secondary heat transfer surfaces that project from the corresponding primary heat transfer surface and with at least one of the heat exchange elements provided adjacent to each of the heater elements, a control module that includes electronics and is electrically connected to the electric motor and to the heater elements, and a flowpath through which a coolant fluid is flowable. The flowpath fluidically passes from an inlet to the pump, to a first manifold downstream of the pump, to a second manifold downstream of the first manifold, and to an outlet downstream of the second manifold. The flowpath can further include a first flowpath segment that passes along at least one of the heat exchange elements to permit heat transfer therebetween, such that at least a portion of the coolant fluid present in the first flowpath segment can be heated, and a second flowpath segment that passes in close proximity to at least a portion of the electronics of the control module to permit heat transfer therebetween, such that at least the portion of the electronics of the control module are coolable by transferring heat to a portion of the coolant fluid present in the second flowpath segment.

In some embodiments, the pump and heater assembly can optionally be part of a vehicle that further includes an on-board high-voltage electric power source electrically connected to the pump and heater assembly, a liquid-to-air heat exchanger, and a fluid circuit fluidically connecting the heat exchanger and the pump and heater assembly.

In another aspect, a method of electrically heating and pumping a coolant fluid can include providing electric power to a motor and to a plurality of heater elements using a shared control module that includes electronics, operating the motor to drive a pump, pressurizing the coolant fluid with the pump, distributing a first portion of the pressurized coolant fluid to a first flowpath segment and a second portion of the pressurized coolant fluid to a second flowpath segment, passing the first portion of the pressurized coolant fluid in the first flowpath segment along a plurality of heat exchange elements, with each of the plurality of heat exchange elements is located adjacent to at least one of the heater elements, generating thermal energy with at least one of the heater elements, heating the first portion of the pressurized coolant fluid through conductive transfer of at least some of the thermal energy generated with the heater elements to the first portion of the pressurized coolant fluid through at least some of the plurality of heat exchange elements, passing the second portion of the pressurized coolant fluid in the second flowpath segment near at least a portion of the electronics of the control module to provide cooling, such that waste heat from at least the portion of the electronics is transferred to the second portion of the pressurized coolant fluid, and moving the first portion of the pressurized coolant fluid and the second portion of the pressurized coolant fluid through an outlet bore to exit the pump and heater assembly.

In another aspect, a pump and heater assembly can include an electric motor, a pump operatively connected to the electric motor, one or more heater elements each configured to generate heat through electrical resistance, a control module electrically connected to the electric motor and to the heater elements, with the control module including switching electronics usable to control operation of the electric motor, and a flowpath through which a coolant fluid is flowable, the flowpath fluidically passing to a first manifold downstream of the pump, to both first and second flowpath segments branching from the first manifold, and to a second manifold downstream of both the first and second flowpath segments. The first flowpath segment passes proximate to the heater elements to enable heating of a portion of the coolant fluid present in the first flowpath segment. The second flowpath segment passes through the control module proximate to the switching electronics to enable cooling of the switching electronics by a portion of the coolant fluid present in the second flowpath segment. The first and second flowpath segments can be arranged fluidically in parallel.

The present summary is provided only by way of example, and not limitation. Other aspects of the present invention will be appreciated in view of the entirety of the present disclosure, including the entire text, claims, and accompanying figures.

### BRIEF DESCRIPTION OF THE DRAWINGS

FIG. 1 is a schematic electrical and hydraulic diagram of an embodiment of a system with separate pump and heater devices connected by electrical cables, fluid hoses, and associated electrical and fluidic connectors.

FIG. 2 is a schematic electrical and hydraulic diagram of an embodiment of a system with a combined pump and heater assembly.

FIG. 3 is a schematic block diagram of an embodiment of a zero-emission vehicle (ZEV) having a pump and heater assembly.

FIG. 4 is a schematic diagram of an embodiment of a pump and heater assembly.

FIGS. 5A and 5B are cross-sectional views of an embodiment of a pump and heater assembly, with arrows representing fluid flow annotated in FIG. 5B, and FIG. 5C is an enlarged cross-sectional view of a portion of FIG. 5A.

FIG. 6A is a rear perspective view of the pump and heater assembly of FIGS. 5A-5C, shown with a control module cover omitted to reveal interior structures.

FIG. 6B is a sectional view of the pump and heater assembly, taken along line 6B-6B of FIG. 6A.

FIG. 7 is a cross-sectional perspective view of a portion of a heater section of the pump and heater assembly of FIGS. 5A to 6B.

FIGS. 8A and 8B are cross-sectional views of another embodiment of a pump and heater assembly, with arrows representing fluid flow annotated in FIG. 8B.

FIG. 9A is a rear elevation view of a portion of a combined motor and heater module of the pump and heater assembly of FIGS. 8A and 8B.

FIG. 9B is an enlarged rear perspective view of part of the combined motor and heater module shown in FIG. 9A.

FIG. 10 is a perspective view of a heater set of the pump and heater assembly of FIGS. 8A to 9B, shown in isolation.

FIG. 11 is a sectional perspective view of another embodiment of a pump and heater assembly, with certain portions omitted for simplicity.

FIG. 12 is a sectional view of the pump and heater assembly, taken along line 12-12 of FIG. 11.

While the above-identified figures set forth one or more embodiments of the present invention, other embodiments are also contemplated as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps, and/or components not specifically shown in the drawings.

### DETAILED DESCRIPTION OF ILLUSTRATIVE EMBODIMENTS

It is desired to provide an on-board electrically-powered heater that can warm a coolant fluid that can be pumped through a climate control heat exchanger providing heat for a cabin, sleeper, cargo space, or the like. The heat load can be approximately 10-70 kW, for example, depending on the need and application. Because of the relatively high heat load requirements, it is desirable to utilize high voltage power present from at least one on-board battery or fuel cell to power the heater. The voltage of such an on-board power source used for a traction motor in a zero-emission vehicle (ZEV) can range from approximately 400-1200 V DC, for example, or 450-850 VDC, as another example. The on-board power source may have a nominal operating voltage but may have an operating voltage that varies across actual operating conditions, such as a temporarily reduced operating voltage during near-depletion conditions when the on-board power source is made up of one or more batteries nearing full discharge. There may be a minimum operating voltage, such as approximately 400 VDC or greater, to account for such variations in operating voltage. The design can be modular, such that essentially any desired number of discrete heater elements can be used together for particular applications (e.g., to provide desired overall heating capacity), while still permitting the assembly to be provided as an integrated unit. The discrete heater elements can be electrically resistive elements in some embodiments, or can have a different configuration to operate on a different basis in other embodiments.

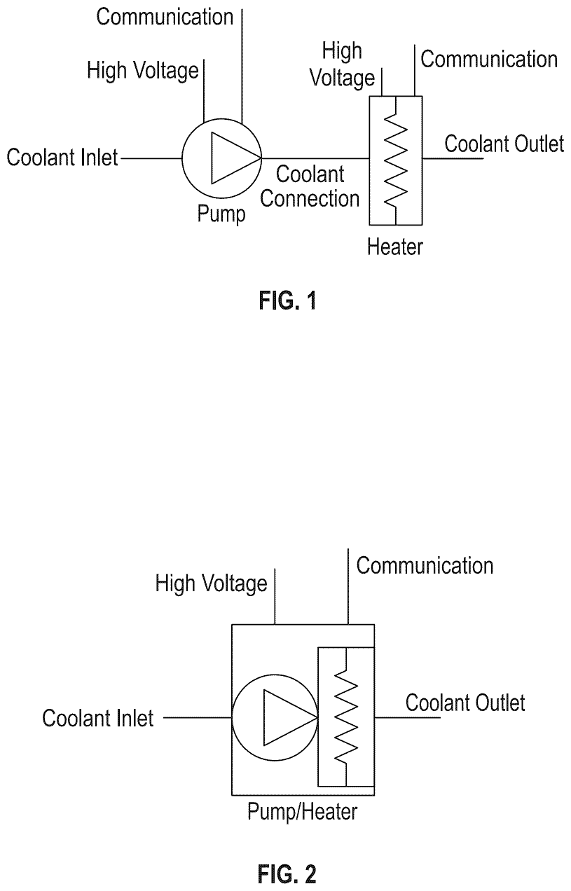

There is also a need to pump the coolant fluid through the system and through other components for heating or cooling purposes. These pump(s) would also benefit from operating using power from the on-board high voltage power supply. The amount of electrical power a cable can conduct is proportional to the amount of current that it can carry. Because the electrical power is a function of the current multiplied by the voltage, an increase in voltage causes a like drop in current. Furthermore, the amount of current a cable can carry is related to the cross-sectional area of the wire, which is dependent on the square of the diameter (for cables with a generally circular cross-sectional shape). Thus, the cable sizes can be decreased exponentially with an increase in the voltage. This is very important in consideration of weight and packaging. In vehicular applications, providing a relatively low mass and relatively compact design for on-board components and systems is important. However, high voltage connectors suitable for use in vehicles are expensive and require great care in installation and application. Further, running high voltage wires to multiple devices is expensive and complex. It is desired to minimize the number of wires and connections. Moreover, it is desired to allow for wire routing that makes fabrication and assembly relatively easy by avoiding complex and/or difficult-to-access wiring paths. Disclosed embodiments of the present invention provide a pump and heater assembly that will reduce or eliminate the need for separate wiring and connections to both the pump and the heater and/or provide for relatively easy wiring during fabrication and assembly. Additionally, embodiments of the present invention aim to reduce the number of fluidic coolant connections and/or hoses. FIGS. 1 and 2 illustrate schematically how electrical cables, fluid hoses, and various associated connectors needed for separate pump and heater devices (see FIG. 1) can be eliminated in a combined assembly (see FIG. 2). For instance, even though there are internal fluid and electrical connections in the combined assembly of FIG. 2, such internal connections may not require the kinds of cables, hoses, etc. that are needed outside of an enclosure, and can be integrated with internal components or lighter weight and/or less expensive cables and connectors can be used inside a protective enclosure of the combined assembly.

In general, embodiments of a pump and heater assembly according to the present invention include a pump element driven by an electric motor (e.g., a permanent magnet brushless DC motor or synchronous DC motor), one or more housings, and one or more heating element(s) operatively positioned in, along, or near a flowpath through the assembly of a pumped fluid referred to as a coolant. A control electronics and electrical connector module can further be provided, or such components can alternatively be integrated into the motor, for instance. In some embodiments, a common control module can be provided suitable for driving both the motor for the pump as well as the heater element(s). The pump element can be a vaned or finned rotor driven by torque from a shaft of the motor. A housing, or another component of the assembly, can direct the coolant around the motor (for example, from the pump located at one end of the assembly through at least one pathway adjacent to the motor toward an opposite end of the assembly). One or more heater element(s) can be located in a different part of the assembly, such as at an opposite end of the assembly from the pump, for instance by being attached to or otherwise supported on an end of the motor opposite the pump. Flow of the coolant is directed past the heater element(s) to an outlet or exit of the assembly's flowpath. The heater element(s) can each be an electrically resistive heater device. When electrical current is passed through a given heater element, its resistance causes the heater element to warm up. This heat is transferred to the flowing coolant moving by the pump, thus heating the coolant. In this sense, the term coolant should be understood as allowing for both cooling or heating, as will be well understood by persons of ordinary skill in the art. Furthermore, a heat exchanger or heat exchange element can be provided adjacent any or all of the heater element(s) to facilitate transfer of thermal energy to the coolant. Controlling the amount of current delivered to the heater element allows for control of the coolant temperature exiting the pump and heater assembly. The assembly can have a modular construction, allowing a desired number of discrete heater element(s) (and any associated heat exchangers or heat exchange elements) to be provided to provide a heating capacity suitable for a desired application, while still allowing for both fluidic and electrical connections for the pump and heater assembly to be made relatively easily. Furthermore, the configuration of the assembly, and the arrangement of components within it, can facilitate making electrical connections between internal and external electrical components (for instance, the motor, the heater elements(s), the control module, an external power source, and/or external controller) as well fluidic connections between internal and external components associated with a coolant circuit that includes the flowpath through the assembly. And such electrical and fluidic connections can be made by or with the assembly relatively easily and without significant conflicts between electrical and fluidic connections or pathways present in close proximity.

It should be understood that the present disclosure is provided merely by way of example and not limitation, and that numerous embodiments and implementations are contemplated, as will be understood by persons of ordinary skill in the art upon review of the entirety of the present disclosure including the text and accompanying drawings.

The present application is based on and claims the benefit of U.S. provisional patent application Ser. No. 63/374,333, filed Sep. 1, 2022, the content of which is hereby incorporated by reference in its entirety.

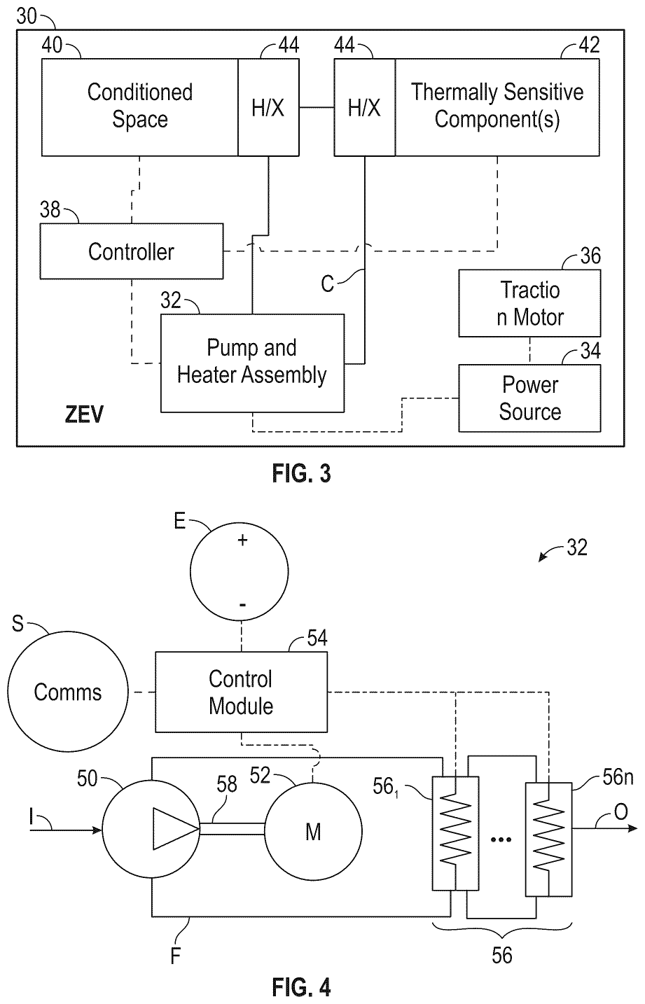

FIG. 3 is a schematic block diagram of an embodiment of a zero-emission vehicle (ZEV) 30 having a pump and heater assembly 32. As shown in FIG. 3, the pump and heater assembly 32 can receive high voltage electrical power (for example, 400-1200 V DC) from an on-board power source 34 (for example, one or more batteries or fuel cells), which can optionally also supply power to other on-board devices such as a traction motor 36. A controller 38 communicates with the pump and heater assembly, such as through a controller area network (CAN) communication protocol as is well known for automotive applications. In various embodiments, the controller 38 can be an overall vehicle controller, such as a central on-board computer that also controls components like the traction motor 36, or can be a separate controller that is dedicated to heating and/or cooling related functions. The controller 38 can generate and/or relay heating demand signals to the pump and heater assembly 32, for instance, based on operator commands, sensor measurements and associated control determinations and protocols, and/or the like. A fluid circuit C can circulate a coolant fluid through the ZEV 30 to provide thermal management to a conditioned space 40 (for example, a cabin or sleeper area of the ZEV or a cargo space, including a trailer cargo space) and/or thermally sensitive onboard components 42 (for example, on-board electronics, batteries, etc.). The coolant fluid can be, for instance, a liquid such as water, water plus an anti-freeze agent, or another suitable fluid. One or more heat exchangers (H/X) 44 can optionally be provided along the fluid circuit C, and can optionally include blowers, air handlers, or the like where liquid-to-air or air-to-liquid heat transfer is involved is provided. Although not shown in FIG. 3, additional heating, ventilation and air conditioning (HVAC) components can optionally be provided along the fluid circuit C. For instance, the same fluid circuit C can be connected to the pump and heater assembly 32 to provide heat as well as to an air conditioner or refrigeration unit (not shown) to remove heat and provide cooling. In still further embodiments, the fluid circuit C could be a dedicated fluid circuit for the pump and heater assembly 32, optionally used in conjunction with an additional, fluidically isolated supplemental fluid circuit (not shown). It should be noted that FIG. 3 is a highly simplified schematic representation and various alternative configurations are possible, and various additional equipment not specifically shown can be included in further embodiments. For instance, there can be additional electrical and/or fluidic connections between components of the ZEV 30, sensors, valves, etc. Moreover, there could be multiple pump and heater assemblies 32, multiple power sources 34, and/or multiple traction motors 36 carried on board the ZEV 30 in further embodiments. Additionally, as shown in the embodiment of FIG. 3, the traction motor 36 is separate and distinct from the pump and heater assembly 32 and those components are merely both carried on board and commonly electrically powered, although in further embodiments waste heat from the traction motor 36 might be divertible to the fluid circuit C, with the pump and heater assembly 32 providing heat output when other waste heat is unavailable or inadequate.

FIG. 4 is a schematic diagram of an embodiment of the pump and heater assembly 32. As shown in FIG. 4, the assembly 32 includes a pump 50, an electric motor 52, a control module 54, and one or more electrically-powered heater elements 56₁ to 56ₙ.

As illustrated, the control module 54 receives electrical power input E to the assembly (for example, from the power source 34), provides combined control and power distribution to the motor 52 and the electrically-powered heater elements 56₁ to 56ₙ (collectively, heater module 56), and further coordinates external communications (comms) signals S (for example, communicating with the external controller 38 via CAN communication protocols).

The pump 50 is mechanically driven by a torque output from an output shaft 58 that is part of or otherwise operatively connected to the motor 52, such that the motor 52 can rotate the output shaft 58 to drive or operate the pump 50. A pump element of the pump 50 can be directly or indirectly connected to the output shaft 58 to accept torque conveyed from the motor 52. In various embodiments, the pump 50 can be an impeller-driven centrifugal pump, a scroll pump, a piston pump, or other suitable type of pump.

A flowpath F that forms a portion of the fluid circuit C traversing the pump and heater assembly 32 can pass through an inlet I to the pump 50 and then past at least the motor 52 to the heater element(s) 56₁ to 56ₙ. The fluid circuit C can have one or more flowpath segments arranged adjacent to and in close proximity to the motor 52 (and, optionally, also the control module 54), such that thermal energy can be transferred between them. Waste heat from the motor 52 (and/or from the control module 54) can be transferred to the passing coolant fluid, allowing cooling of the motor 52 and/or electronics of the control module 54. The coolant fluid can then pass by or through the heater element(s) 56₁ to 56ₙ and absorb thermal energy generated by one or more of those heater clement(s) 56₁ to 56ₙ. The design of the pump and heater assembly 32 is modular such that as few as one heater element 56-1 can be used or multiple heater elements 56₁ to 56ₙ can be used, with as many heater elements 56₁ to 56ₙ, used as is needed to obtain the required heat (e.g., to satisfy a maximum anticipated heating demand or otherwise satisfy a desired heating capacity) and to satisfy hydrodynamic pressure requirements. For instance, in some embodiments, a heat load of approximately 10-40 kW can be satisfied by the assembly 32. In some embodiments, a single pump 50 can be used in the assembly 32 regardless of the number of heater element(s) 56₁ to 56ₙ. The heated coolant fluid can then exit an outlet O of the pump and heater assembly 32 for delivery to desired locations by the fluid circuit C.

Although not specifically shown in FIG. 3 or 4, sensors can be used for monitoring coolant fluid temperature, flow rate, pressure, and/or other desired parameters, and such sensors can communicate with the control module 54 either directly or via another controller or device (e.g., indirectly via the controller 38 of the ZEV 30 using communications signals S sent between the controller 38 and the control module 54). Such sensors can be located at essentially any desired locations along the fluid circuit C.

Additionally, although not explicitly shown in FIG. 4, the pump and heater assembly 32 can include an enclosure. Moreover, the entire assembly 32 can be provided as an integrated unit in some embodiments.

While FIG. 4 illustrates an embodiment of the flowpath F with the heater element(s) 56₁ to 56ₙ fluidically connected in series, other arrangements are possible in further embodiments. For example, in alternate embodiments, the flowpath F can fluidically connect individual heater elements 56₁ to 56ₙ in parallel or in a hybrid parallel/serial multi-pass arrangement. More generally, the configuration and arrangement of components of the ZEV 30 and the pump and heater assembly 21 of FIGS. 3 and 4 are shown merely by way of example and not limitation.

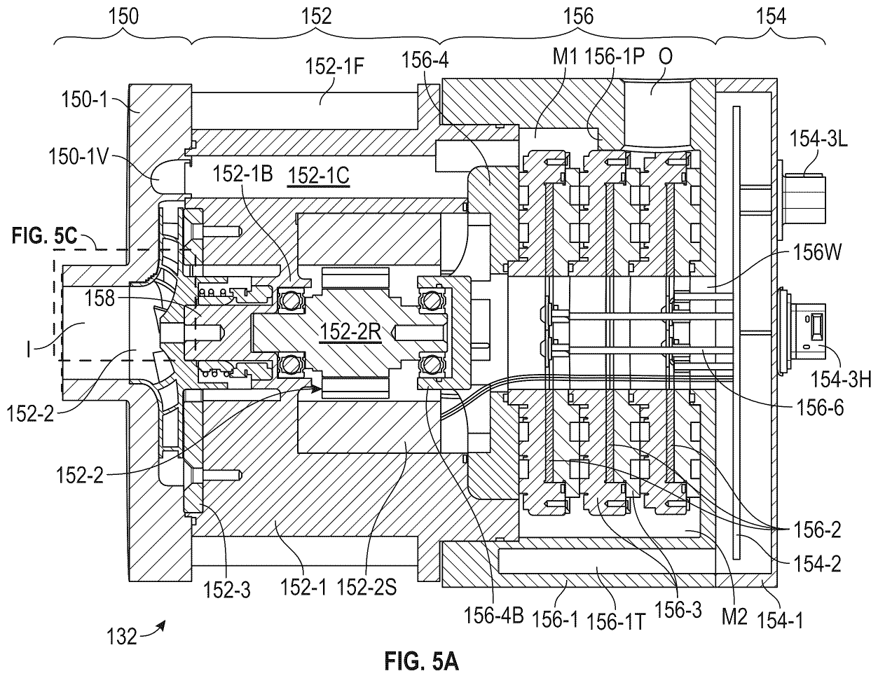

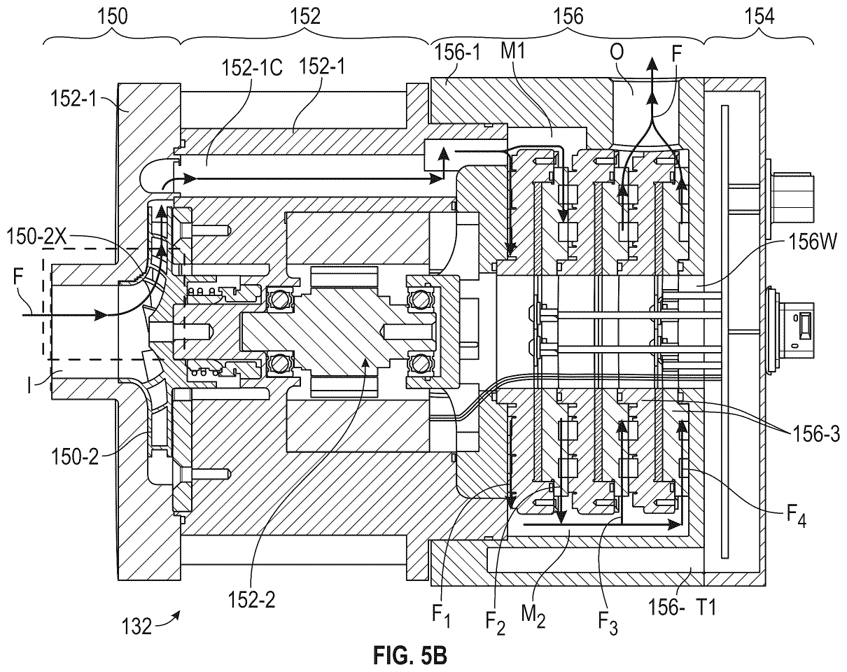

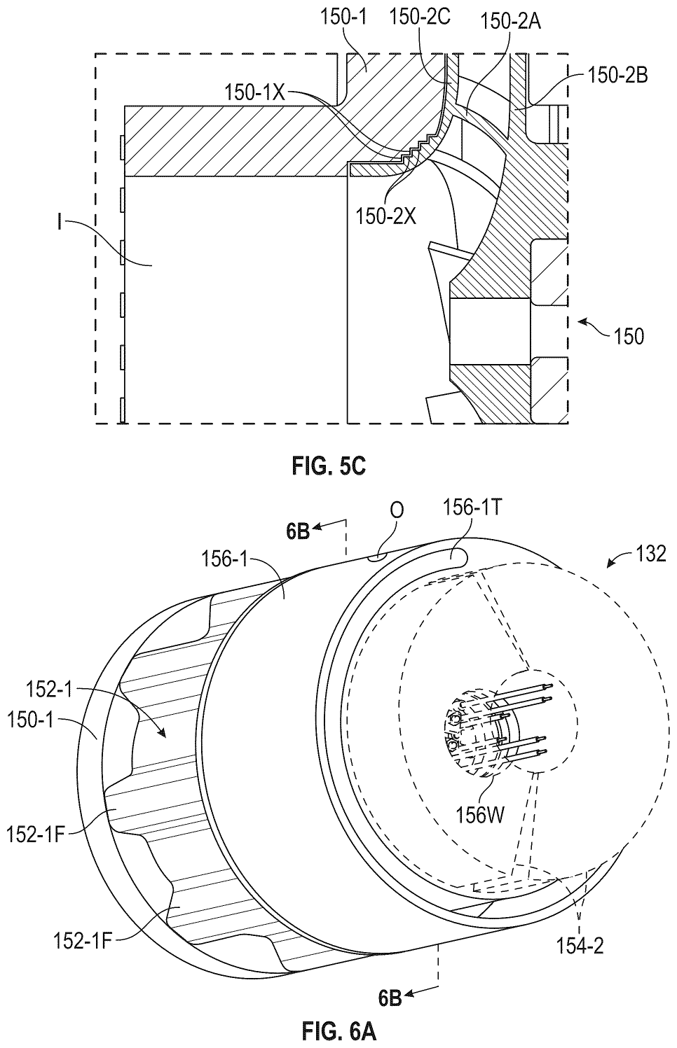

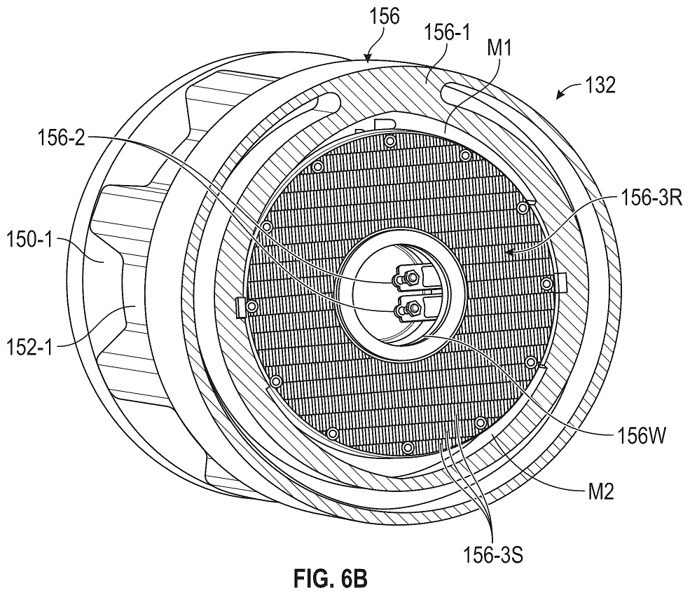

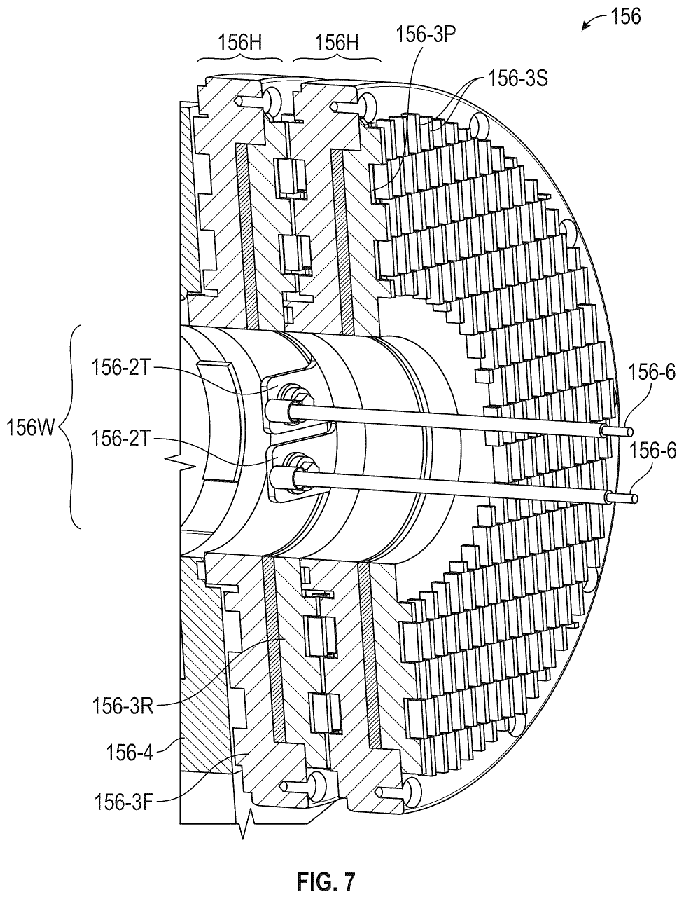

FIGS. 5A to 7 illustrate one embodiment of a pump and heater assembly 132, and components thereof. FIGS. 5A and 5B are cross-sectional views, FIG. 5C is an enlarged cross-sectional view of a selected portion, FIG. 6A is a rear perspective view shown with a portion of the assembly omitted to reveal certain internal space, FIG. 6B is a sectional view taken along line 6B-6B of FIG. 6A, and FIG. 7 is a cross-sectional perspective view of a portion of a heater section.

As shown in FIG. 5A, the pump and heater assembly 132 provides an integrated unit that includes a pump module (or section) 150 at one end, a motor module (or section) 152 at or near a middle portion, a control module (or section) 154 (e.g., at or near an opposite end from the pump module 150), and a heater module (or section) 156 (e.g., in a middle portion in between the motor module 152 and the control module 154). FIG. 5B further shows a flowpath F through the pump and heater assembly 132, with arrows added for illustrative purposes (although it should be noted that the flowpath F in three dimensions is somewhat more complex than what is explicitly represented by the arrows in FIG. 5B).

The pump module 150 includes a pump housing 150-1 and a rotor 150-2. The pump housing 150-1 defines an inlet I, which in the illustrated embodiment is a generally axially-oriented opening located at a center of the pump housing 150-1 and the assembly 132. The inlet I can include a protruding collar, boss, or other coupling structure suitable to connect a hose, conduit, or other passageway of the fluid circuit C to the pump and heater assembly 132 to allow a coolant fluid to enter the pump and heater assembly 132. Although a single inlet I is shown in the illustrated embodiment, multiple discrete inlet structures and/or an inlet manifold could be utilized in further embodiments. In the illustrated embodiment, the rotor 150-2 is a radial flow impeller as part of a centrifugal pump configuration of the pump module 150, although other configurations are possible. The pump housing 150-1 and the rotor 150-2 together define a segment of the flowpath F. In the illustrated embodiment, the pump housing 150-1 is configured as a volute housing or casing volute channel 150-1V. Pump volute casings are well-known, making further explanation unnecessary.

During operation, the coolant fluid entering the inlet I passes to the rotor 150-2, which pressurizes the coolant fluid and moves it along the flowpath F. In the illustrated embodiment, as shown in FIG. 5B, the rotor 150-2 and the housing 150-1 of the pump module 150 move the pressurized coolant fluid generally outward (e.g., along a curved volute path) and toward the motor module 152.

As shown in FIG. 5C, illustrated embodiment of the rotor 150-2 has a closed or shrouded configuration and includes fins or vanes 150-2A, a back wall 150-2B, and a front wall (or shroud) 150-2C. A seal element located adjacent to the rotor 150-2 can be spring biased to an operating position, in some embodiments. One or more stepped protrusions 150-2X extend from the front wall 150-C of the rotor 150-2 toward the pump housing 150-1 at a location where the front wall 150-2C curves. A corresponding set of stepped recesses 150-1X are provided in the pump housing 150-1 which accept at least portions of the stepped protrusions 150-2X. The stepped protrusions and recesses 150-2X and 150-1X together define a labyrinthine path between the pump housing 150-1 and the front wall 150-2C of the rotor 150-2, which helps limit recirculation of the coolant fluid in regions along or bordering the desired flowpath F that passes by the fins 150-2A in between the back and front walls 150-2B and 150-2C. In other words, pump module 150 is intended to pressurize the coolant fluid, which is meant to be moved along the flowpath F and through the coolant circuit C without dwelling in the pump module 150, and the labyrinth defined by the stepped protrusions and recesses 150-2X and 150-1X helps limit unproductive recirculation that may otherwise cause portions of the coolant fluid to inefficiently dwell in the pump module 150 rather than move through and past the pump module 150 during operation.

The motor module 152 is capable of generating force to drive or operate the pump module 150, such as torque to rotate the rotor 150-2 via a shaft 158. The motor module 152 can be located adjacent to the pump module 150. In the illustrated embodiment, as shown in FIGS. 5A and 5B, the motor module 152 is located axially adjacent to the pump module 150. In the illustrated embodiment, the motor module 152 includes a motor housing 152-1, a motor 152-2, and a plate 152-3 (which can be used to cover mass reduction cavities).

The motor housing 152-1 can partly or entirely surround the motor 152-2, and can be connected to the pump housing 150-1. In the illustrated embodiment, the motor housing 152-1 has a central cavity in which the motor 152-2 (or at least portions thereof) can be positioned and fins (or lugs) 152-1F at an outer region. The motor housing 152-1 has a quasi-cylindrical shape in the illustrated embodiment, although other shapes are possible in alternative embodiments. At least one flow channel 152-1C passes through the motor housing 152-1 that forms a segment of the flowpath F through the pumper and heater assembly 132. In the illustrated embodiment, the flow channel 152-1C is located radially outward from the motor 152-2 and the associated central cavity of the motor housing 152-1 and axially traverses an entire length of the motor housing 152-1. Moreover, in the illustrated embodiment, the flow channel 152-1C is substantially linear and arranged axially, although in alternate embodiments other configurations are possible. The flow channel 152-1C can be fluidically connected in series to the volute channel 150-1V, and can accept pressurized coolant fluid that leaves the pump module 150. In alternate embodiments, the flow channel 152-1C could be provided through one or more hoses, which could optionally be connected through one or more valves.

The motor 152-2 includes a rotor 152-2R and a stator 152-2S. The motor 152-2 can be, for example, a permanent magnet brushless DC motor (or synchronous DC motor), with permanent magnets carried by the rotor 152-2R, and can optionally have a three-phase configuration. The rotor 152-2R is directly or indirectly connected to the shaft 158, which in turn is directly or indirectly connected to the rotor 150-2 of the pump module 150, such that torque generated by the motor 152-2 can be transmitted to the rotor 150-2 to operate the pump module 150 to pressurize the coolant fluid. At least one end of the rotor 152-2R (e.g., an end adjacent to the pump module 150) can be supported by the motor housing 152-1 via suitable bearings at a bearing pilot 152-1B, while an opposite end of the rotor 152-2R can be supported on the heater module 156 via additional bearings, in some embodiments.

During operation, waste heat from the motor 152-2 can be absorbed by the coolant fluid passing along the flowpath F through the flow channel 152-1C (see FIG. 5B). In the illustrated embodiment, the flowpath F passes outward of the motor 152-2 through the flow channel 152-1C upstream from the heater module 156 (and heater elements contained therein, as will be explained further). Gaps between the fins 152-1F help to reduce the mass of the motor housing 152-1 and of the overall pump and heater assembly 132 (see FIG. 6A), and can potentially further provide some thermal isolation and insulating airspace between the flow channel 152-1C and any external objects present nearby.

The control module 154 can include a cover (or housing) 154-1, circuitry 154-2, and one or more electrical connectors 154-3H and 154-3L. In the illustrated embodiment, the control module 154 is located at or near an opposite end of the pump and heater assembly 132 from the pump module 150, although other arrangements of the control module 154 are possible in alternate embodiments. The circuitry 154-2 can include one or more circuit boards, and can provide motor control functionality to operate the motor 152-2 of the motor module 152 and heater control functionality to operate the heater module 156. For example, the motor control functionality of the circuitry 154-2 can be provided utilizing switching transistors such as integrated-gate bipolar transistors (IGBTs) or silicon carbide (SiC) metal-oxide-semiconductor field-effect transistors (MOSFETs), in embodiments in which the motor 152-2 has a brushless DC configuration. In the illustrated embodiment, one of the connectors is a high voltage electrical connector 154-3H and another is a low voltage electrical connector 154-3L. The high voltage electrical connector 154-3H can, for instance, provide high voltage power input (e.g., at approximately 400-1200 V DC, or approximately 850-1200 V DC or approximately 850-900 V DC, in various embodiments) to the circuitry 154-2 to power the heater module 156 and/or the motor 152-2, and optionally also high voltage interlock loop (HVIL) signal lines. The low voltage electrical connector 154-3L can, for instance, provide communications signals, such as when connected to external communications network (e.g., a CAN bus of the ZEV 30), and/or low voltage power input, such as for powering low voltage portions of the circuitry 154-2 used for communications, etc. The circuitry 154-2 can include, or be supplemented by, electromagnetic interference (EMI) filter circuitry, similar or identical to that disclosed in PCT International Pat. App. No. PCT/US2023/64617, for example.

The heater module 156 of the illustrated embodiment includes a heater housing 156-1, one or more heater elements 156-2 (for example, three, as shown) and corresponding heat exchange elements 156-3, a base 156-4, a first manifold M1, and a second manifold M2. The heater module 156 can be located adjacent to the motor module 152, and can be operatively connected axially in between the motor module 152 and the control module 154.

The heater housing 156-1 can be operatively connected axially in between the motor housing 152-1 and the cover 154-1 in some embodiments. In the illustrated embodiment, the heater housing 156-1 includes a thermal break 156-1T and further defines an outlet O. The first manifold M1 can be fluidically connected to the flow channel 152-1C in the flow path F, with the second manifold M2 located downstream from the first manifold M1 in the flow path F, and with the outlet O located downstream from the second manifold M2 in the flow path F. In the illustrated embodiment, an inward protrusion 156-1P of the heater housing 156-1 defines a boundary of the first manifold M1, which provides a fluid barrier between the first manifold M1 and the outlet O in order to provide a desired configuration of the flowpath F as explained further below. Other components such as the base 156-4 can further define boundaries of the first manifold M1. In the illustrated embodiment, the first and second manifolds M1 and M2 are located at discrete angular or circumferential locations with semi-annular interior volumes and can be located opposite or diametrically opposed to one another at radially outward portions of the heater module 156. One or more additional manifolds can be utilized in further embodiments, such as where a greater number of heater elements 156-2 are present. The outlet O can allow the coolant fluid passed along the flowpath F to exit the pump and heater assembly 132, and to pass to other portions of the fluid circuit C. The thermal break 156-1T can include at least one channel or cavity located between the flowpath F and an exterior of the heater module 156, such as a curved channel near an outer perimeter of the heater housing 156-1 as shown in the illustrated embodiment, that provides a thermal insulation gap. The thermal break 156-IT could be filled merely with air or optionally another thermal insulation material. The thermal break 156-1T can extend over a majority of the axial length of the heater housing 156-1 in some embodiments. In the illustrated embodiment, the thermal break 156-1T is open to an interior volume of the control module cover 154-1. The thermal break 156-IT can help promote efficiency by retaining heat within the assembly 132 and also potentially prevent exterior surfaces of the heater module 156 from becoming too hot. Added thermal insulation can optionally be placed along or around exterior surfaces of the heater housing 156-1 in some embodiments.

A stack of components is provided at least partially within an interior cavity of the heater housing 156-1 that establishes a non-linear segment of the flowpath F that passes in functional proximity to the heater elements 156-2 and corresponding heat exchange elements 156-3 while still permitting electrical connections (e.g., wiring) to be present without interfering with the flowpath F and optionally providing mechanical support for the motor 152-2. The stacked arrangement of the heater elements 156-2 and corresponding heat exchange elements 156-3 allows for a modular configuration within the heater module 156, such that the total number of the heater elements 156-2 (and optionally also the number of corresponding heat exchange elements 156-3) can vary as desired for particular applications in order to adjust operational parameters like heating capacity and to satisfy hydrodynamic pressure requirements. For instance, a larger or smaller number of the heater elements 156-2 can be included in further embodiments in order to provide a larger or smaller heating capacity. In embodiments in which fewer of the heater elements 156-2 are utilized, there can be heat exchange elements 156-3 provided that lack a corresponding heater clement 156-2, or alternatively heat exchange elements 156-3 can be omitted and the heater housing 150-1 and/or other components of the heater module 156 modified to accommodate a modified segment of the flowpath F through the heater module 156. Yet, modifications to the configuration of the heater module 156 can involve little or no modification to other modules of the pump and heater assembly 132, such that the same configurations of the pump module 150, the motor module 152, and/or the control module 154 can be utilized with a range of different configurations of the heater module 156. Such a modular construction means that the basic design of the pump and heater assembly 132 and certain common core sub-components can be utilized for a relatively wide variety of applications with different operating requirements for heat capacity and the like by making changes to only a limited number of sub-components (such as only to selected components of a single module).

As shown in the illustrated embodiment, the base 156-4 is located adjacent to the motor module 152 and provides a bearing pilot 156-4B. The base 156-4 can be configured as a single monolithic piece or as an assembly of multiple discrete components in various embodiments. One end of the rotor 152-2R of the motor 152-2 can be rotatably supported on the bearing pilot 156-4B by suitable bearings (that is, additional bearings). Such an arrangement allows for a more axially compact arrangement of the pump and heater assembly 132. For instance, in some embodiments, the motor housing 152-1 directly supports one end of the rotor 152-2R via the bearing pilot 152-1B while the opposite end of the rotor 152-2R is supported by the bearing pilot 156-4B that is part of a component that is separable from the motor housing 152-1, thus sharing the structural support functions between different modules of the assembly 132. Although in further embodiments the rotor 152-2R could be supported solely by or within the motor module 152, such that the motor module 152 and the heater module 156 are more mechanically distinct than in the illustrated embodiment.

As shown in the illustrated embodiment, the heater elements 156-2 are generally planar, annular electrically resistive heating elements that generate heat when electric current is applied to them. For instance, the electrically resistive heating elements can be of a known type of ceramic heating element in some embodiments. FIG. 7 shows a portion of the heater module 156 in isolation, with certain components omitted in order to better show two of the heater elements 156-2 and the corresponding heat exchange elements 156-3 in a stacked relationship. For a given one of the heater elements 156-2 in the illustrated embodiment, there are front and rear heat exchange elements 156-3F and 156-3R with the corresponding heater element 156-2 sandwiched in between them to form a heater set 156H. The front and rear heat exchange elements 156-3F and 156-3R can provide an at least liquid-tight seal around the corresponding heater element 156-2 to isolate and separate the corresponding heater element 156-2 from the flowpath F and the coolant fluid. The front and rear heat exchange elements 156-3F and 156-3R can be made of metallic material that is a relatively good thermal conductor, such as aluminum. In alternate embodiments, the front and rear heat exchange elements 156-3F and 156-3R could be combined as a single monolithic piece, or could be made up of more than two pieces connected together. During operation, heat can conduct from both sides (or optionally just one side) of each heater element 156-2 through the front and rear heat exchange elements 156-3F and 156-3R to the coolant fluid present in adjacent portions of the flowpath F.

Additionally, a passage 156W is provided by the heater module 156 formed at least in part by corresponding passage openings through each of the heater elements 156-2, the heat exchange elements 156-3, and the heater housing 156-1. In the illustrated embodiment, the passage 156W is configured as a central, substantially linear, axially-extending opening. Electrical connections, such as using wires, cables, or the like, can be routed through the passage 156W, which is separated from the flowpath F by an at least liquid-tight seal. For example, portions of the heat exchange elements 156-3 and the heater housing 156-1 can form boundaries of the passage 156W and create fluid barriers. One or more seal elements, such as O-ring seals, membranes, barrier tubes, or the like can further be provided to suitably fluidically isolate the passage 156W from the flowpath F and the coolant fluid (e.g., providing at least a liquid-tight seal between them). Electrical connections to the heater elements 156-2 can be made within or through the passage 156W. The passage 156W can further provide a mass reduction function. The passage 156W can contain air or otherwise can optionally have a thermal insulating material inserted inside. In the illustrated embodiment, tabs 156-2T extend radially inward from each of the heater elements 156-2, and terminals 156-5 (e.g., screw-clamp terminals, ring terminals, etc.) electrically connect wires 156-6 to the heater elements 156-2 at the tabs 156-2T. The wires 156-6 are further electrically connected to the circuitry 154-2 of the control module 154. In some embodiments, clocking can be used to rotationally position the tabs 156-2T of each heater element 156-2 at different offset or staggered angular positions, and furthermore the terminals 156-5 can be individually arranged and/or rotated, so that electrical connections (e.g., via the wires 156-6) can be made without interfering with each other. In this way, the passage 156W can provide relatively easy access to make electrical connections to the heater elements 156-2 after they are stacked up within the heater housing 156-1. For instance, electrical connections can be made or other actions performed in the passage 156W with line-of-sight access (before the cover 154-1 of the control module 154 is installed or after it is removed) in some embodiments. Moreover, because the pump and heater assembly 132 can be utilized in vehicular applications, in which vibration and other forces may act on electrical connections, relatively sturdy electrical connections can be made in the passage 156W (e.g., with threaded stud terminals), which can be facilitated by having line-of-sight access during fabrication.

As shown in FIGS. 6B and 7, for example, the front and rear heat exchange elements 156-3F and 156-3R can have primary and secondary heat transfer surfaces 156-3P and 156-3S. The primary heat transfer surfaces 156-3P can be generally planar base surfaces. The secondary heat transfer surfaces 156-3S can be fins, posts, or the like that extend from the primary heat transfer surfaces 156-3P. The secondary heat transfer surface(s) 156-3S can be staggered, such as in a repeating quincunx pattern. For example, in the illustrated embodiment shown in the most detail in FIG. 7, the secondary heat transfer surfaces 156-3S are configured as fins each having an elongated generally rectangular perimeter, arranged to extend in the direction of flow along the flowpath F in staggered rows. Furthermore, the fins forming the secondary heat transfer surfaces 156-3S can each have widths that are less than the flow gap between fins of an adjacent row (e.g., a little less than half of the flow gap). Additionally, a height (e.g., a generally axial dimension) of the secondary heat transfer surfaces 156-3S can be such that a small gap is present between the secondary heat transfer surfaces 156-3S of heat exchange elements 156-3 of adjacent sets 156H that face each other. For instance, where the height of all of the secondary heat transfer surfaces 156-3S are equal or substantially equal, the secondary heat transfer surfaces 156-3S can have a height that is slightly less than half of a spacing distance between the primary heat transfer surfaces 156-3P of adjacent sets 156H that face each other. Further, the arrangement of the secondary heat transfer surfaces 156-3S on facing front and rear heat exchange elements 156-3F and 156-3R of adjacent sets 156H can have the same patterns, such that the fins, pins, or the like substantially align with each other when the sets 156H are stacked together, in some embodiments. However, the illustrated arrangement is disclosed merely by way of example and not limitation. Other configurations and arrangements of the front and rear heat exchange elements 156-3F and 156-3R and the primary and secondary heat transfer surfaces 156-3P and 156-3S are possible in further embodiments, and the secondary heat transfer surfaces 156-3S could even be entirely omitted in alternate embodiments.

During operation, thermal energy transfers from the heater elements 156-2 to the heat exchange elements 156-3, then conducts through material of the heat exchange elements 156-3, which contact the coolant fluid present in adjacent portions F₁ to Fₙ of the flowpath F through the primary and secondary heat transfer surfaces 156-3P and 156-3S. The secondary heat transfer surfaces 156-3S allow for more surface area of the heat exchange elements 156-3 to be in contact with the coolant fluid. Thermal energy, that is, heat, can thereby be transferred, by conduction, from the heat exchange elements 156-3 to the coolant fluid in the portions F₁ to Fₙ of the flowpath F.

Turning to FIG. 5B, it can be seen that in the illustrated embodiment the flowpath F enters the heater module 156 generally axially at the first manifold M1, which then distributes the coolant fluid in parallel to two different generally radial portions of the flowpath F, one portion F₁ between the base 156-4 and the front heat exchange element 156-3F of the forwardmost heater set 156H, and another portion F₂ between the rear heat exchange clement 156-3R of the forwardmost heater set 156H and the front heat exchange element 156-3F of the adjacent (middle) heater set 156H. As the coolant fluid passes along and/or between the sets 156H upon leaving the first manifold M1, the coolant fluid flows around the passage 156W on a generally annular path and then enters the second manifold M2. The coolant fluid can then flow generally axially within the second manifold M2 which then distributes the coolant fluid in parallel to two additional generally radial portions of the flowpath F, one portion F₃ between the rear heat exchange element 156-3R of the middle heater set 156H and the front heat exchange element 156-3F of the rearmost heater set 156H, and another portion F₄ between the rear heat exchange element 156-3R of the rearmost heater set 156H and a rear wall of the heater housing 156-1. As the coolant fluid passes along and/or between the sets 156H upon leaving the second manifold M2, the coolant fluid flows around the passage 156W on a generally annular path and then exits the heater module 156 (and the pump and heater assembly 132) in a generally radial direction through the outlet O, as illustrated. A collection manifold can optionally be provided adjacent to the outlet O to help collect coolant fluid from multiple paths for delivery to the outlet O. Thus, as shown FIG. 5B, the flowpath F through the heater module 156 in some embodiments can have a hybrid parallel/serial multi-pass arrangement, such as with multiple fluidically parallel paths along the heater elements 156-2 that are arranged in flow series to each other in a 2×2 or two pass arrangement. The sets 156H allow for flow of the coolant fluid between them, without the need to fabricate any separate tubes, plates, or the like for fluid flow. The illustrated arrangement is shown merely by way of example and not limitation, and other arrangements are possible in further embodiments, such as in embodiments with a smaller or larger number of heater elements 156-2, a different orientation of the outlet O (for instance, axially arranged).

An enclosure of the pump and heater assembly 132 can be defined by the pump housing 150-1, the motor housing 152-1, the cover 154-1, and/or the heater housing 156-1.

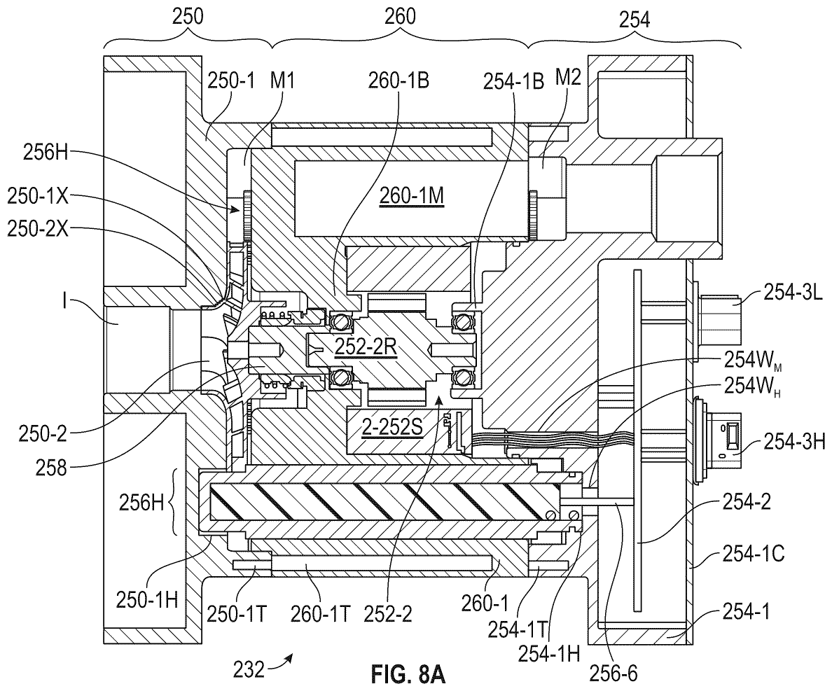

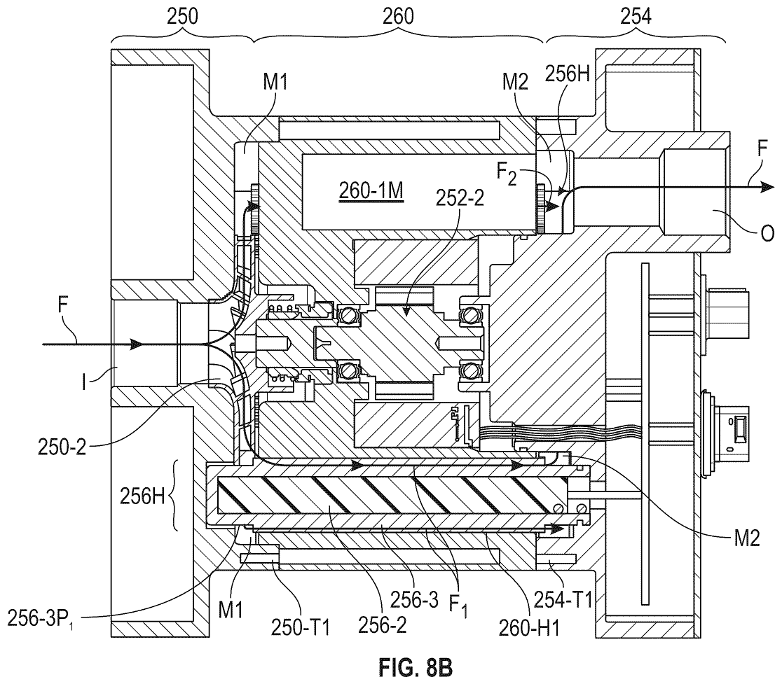

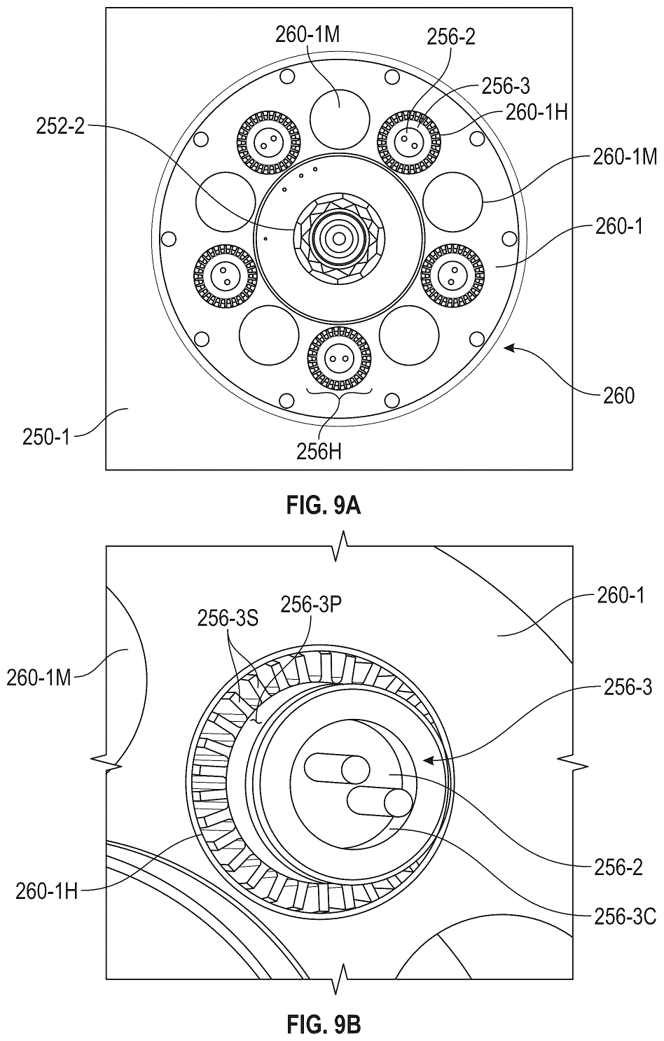

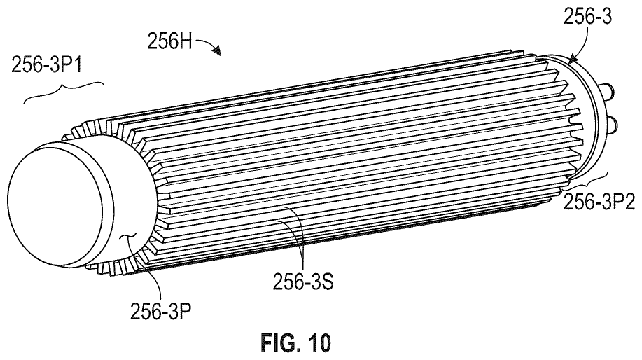

Another embodiment of a pump and heater assembly 232 is shown in FIGS. 8A to 10. FIGS. 8A and 8B are cross-sectional views of the entire pump and heater assembly 232 and FIGS. 9A, 9B, and 10 show portions or components thereof. The pump and heater assembly 232 can be an integrated unit that includes a pump module 250, a control module 254, and a combined motor and heater module 260 (which can constitute the combination of a motor module and a heater module). Because many of the components of the assembly 232 are the same or similar to those of the assembly 132, and frequently operate in a similar manner, similar reference numbers increased by one hundred are utilized.

The pump module 250 includes a pump housing 250-1 and a rotor 250-2 that together define a segment of the flowpath F. The pump housing 150-1 defines the inlet I, which in the illustrated embodiment is a generally axially-oriented opening located at a center of the pump housing 250-1 and the assembly 232, and can optionally include a thermal break 250-1T. The pump housing 250-1 has a profile with a rectangular end portion and a cylindrical rear portion in the illustrated embodiment and lacks a volute but can otherwise be configured similar to the pump module 150 previously discussed, and can function in a similar manner. In further embodiments a volute can be provided in the flowpath F upstream of the first manifold M1, to accept fluid moved by the rotor 250-2 and direct it toward the first manifold M1 in a suitable manner. In the illustrated embodiment, the rotor 250-2 is a radial flow impeller as part of a centrifugal pump configuration of the pump module 250, although other configurations are possible in alternate embodiments. The illustrated embodiment of the rotor 250-2 has a closed or shrouded configuration and includes fins or vanes, a back wall, and a front wall or shroud. One or more stepped protrusions 250-2X extend from the front wall of the rotor 250-2 toward the pump housing 250-1 at a location where the front wall curves, and corresponding set of stepped recesses 250-1X are provided in the pump housing 250-1 that accept at least portions of the stepped protrusions 250-2X. The protrusions 150-2X and the recesses 250-1X can help limit undesired recirculation of the coolant fluid within the pump module 250. During operation, the coolant fluid entering the inlet I passes to the rotor 250-2, which pressurizes the coolant fluid and moves it along the flowpath F. In the illustrated embodiment, as shown in FIG. 8B, the rotor 250-2 and the housing 250-1 of the pump module 250 move the pressurized coolant fluid generally outward and toward the combined motor and heater module 260.

The control module 254 can include a housing 254-1 with a removable cover 254-1C, a thermal break 254-1T, and openings 254W_{H} and 254W_{M}, plus circuitry 254-2 and one or more electrical connectors 254-3H and 254-3L. In the illustrated embodiment, the control module 254 is located at or near an opposite end of the pump and heater assembly 232 from the pump module 250, and has a profile with a rectangular end portion and a cylindrical front portion that adjoins the combined motor and heater module 260, although other arrangements and configurations are possible in alternate embodiments. For instance, the control module 254 could be located adjacent to the pump module 250 instead in further embodiments, and in still further embodiments the control module 254 could be split into any desired number of separate sub-modules dedicated to controlling the pump module 250 and the combined motor and heater module 260. The housing 254-1 can include a bearing pilot 254-1B and can further define the outlet O. The circuitry 254-2 can include one or more circuit boards, and can provide motor control and heater control functionality to operate the combined motor and heater module 260, such as via electrical connections (e.g., wires) routed through the openings 254W_{H} and 254W_{M}, plus communications functionality to communicate with external components or networks, in a manner similar to the control module 154. In the illustrated embodiment, one of the connectors is a high voltage electrical connector 254-3H and another is a low voltage electrical connector 254-3L. The high voltage electrical connector 254-3H can, for instance, provide high voltage power input (e.g., at approximately 400-1200 V DC, or approximately 850-1200 V DC or approximately 850-900 V DC, in various embodiments) to the circuitry 254-2, and optionally also HVIL signal lines. The low voltage electrical connector 254-3L can, for instance, provide communications signals, such as when connected to external communications network (e.g., a CAN bus of the ZEV 30), and/or low voltage power input, such as for powering low voltage portions of the circuitry 254-2 used for communications, etc. The circuitry 254-2 can include, or be supplemented by, EMI filter circuitry.

The combined motor and heater module 260 combines the functionality of the motor module 152 and the heater module 156 but using a combined housing 260-1 and different heater configurations and a different flowpath arrangement than the assembly 132. In the illustrated embodiment, as shown in FIGS. 8A and 8B, the combined motor and heater module 260 is located axially adjacent to and in between the pump module 250 and the control module 254. As explained further below, in the illustrated embodiment, the combined motor and heater module 260 includes the combined housing 260-1, a motor 252-2, and one or more heater sets 256H.

The combined housing 260-1 can be configured as a single monolithic piece (as illustrated) or as an assembly of multiple discrete pieces. In some embodiments, the combined housing 260-1 includes a bearing pilot 260-1B, one or more heater cavities 260-1H, one or more mass reduction cavities 260-1M, and a thermal break 260-1T. In the illustrated embodiment, the combined housing 260-1 has a cylindrical profile. The bearing pilot 260-1B can be arranged at or near a center or middle of the combined housing 260-1, at a cavity for the motor 252-2. The thermal break 260-IT can include at least one channel or cavity between the flowpath F and an exterior of the combined pump and heater module 260, such as a curved channel near an outer perimeter of the combined housing 260-1 as shown in the illustrated embodiment, that provides a thermal insulation gap. The thermal break 254-1T of the control module housing 254-1 can be aligned with the thermal break 260-IT near an exterior of the pump and heater assembly 232, and the thermal break 250-1T of the pump housing 250-1 can open to the thermal break 260-1T of the combined housing 260-1 in some embodiments. The thermal breaks 254-1T and 260-IT can each be filled merely with air or optionally another thermal insulation material. The thermal break 260-IT can extend over a majority of the axial length of the combined housing 260-1 while the thermal break 254-IT can axially extend over only a relatively short distance (e.g., only proximate to a manifold) in some embodiments. The thermal breaks 250-1T, 254-1T, and 260-IT can help promote efficiency by retaining heat within the assembly 232 and also prevent exterior surfaces of the pump and heater assembly 232 from becoming too hot. Added thermal insulation can optionally be placed along or around exterior surfaces of the pump and heater assembly 232 in some embodiments. The mass reduction cavities 260-1M (see FIGS. 8A and 9A) can help reduce the mass of the combined housing 260-1. The number and arrangement of the mass reduction cavities 260-1M can vary depending on the number of heater sets 256H. For instance, while the heater sets mass reduction cavities 260-1M are shown in the illustrated embodiment as axial cavities interspersed with the heater sets 256H in a circumferential pattern, in alternate embodiments the mass reduction cavities 260-1M could be arranged in different directions (e.g., radial) or locations, or could take a form more like the gaps between fins 152-1F.

The motor 252-2 includes a rotor 252-2R and a stator 252-2S and is capable of generating motive force to drive or operate the pump module 250, such as torque to rotate the rotor 250-2 via a shaft 258. The motor 252-2 can be, for example, a permanent magnet brushless DC motor, similar or identical to the motor 152-2. The rotor 252-2R is directly or indirectly connected to the shaft 258, which in turn is directly or indirectly connected to the rotor 250-2 of the pump module 250, such that torque generated by the motor 252-2 can be transmitted to the rotor 250-2 to operate the pump module 250 to pressurize the coolant fluid. At least one end of the rotor 252-2R (e.g., an end adjacent to the pump module 250) can be supported by the bearing pilot 260-1B of the combined housing 260-1 via suitable bearings, while an opposite end of the rotor 252-2R can be supported on the bearing pilot 254-1B of the control module housing 254-1 via additional bearings, in some embodiments, such that the combined housing 260-1 directly supports one end of the rotor 252-2R via the bearing pilot 260-1B while the opposite end of the rotor 252-2R is supported by the bearing pilot 254-1B that is part of a component that is separable from the combined housing 260-1, thus sharing the structural support functions between different modules of the assembly 232 to help provide a more compact overall package. During operation, waste heat from the motor 252-2 can potentially be absorbed by the coolant fluid passing along the flowpath F, which in the illustrated embodiment includes one or more segments that pass outward from the motor 252-2 proximate to portion of the stator 252-2S (sec FIG. 8B). Alternatively, or in addition, insulating air gaps or thermal insulation material could optionally be positioned between at least portions of the motor 252-2 and one or more of the heater sets 256H.

An array of the heater cavities 260-1H and the corresponding heater sets 256H establishes a segment or segments of the flowpath F that passes in functional proximity to the heater sets 256H while still permitting electrical connections (e.g., wiring) to be present without interfering with the flowpath F. A fluidically parallel arrangement of the heater cavities 260-1H and the corresponding heater sets 256H allows for a modular configuration within the combined motor and heater module 260, such that the total number of the heater sets 256H can vary as desired for particular applications in order to adjust operational parameters like heating capacity and to satisfy hydrodynamic pressure requirements, with a corresponding number of discrete parallel portions F₁ to Fₙ of the flowpath F passing by each heater set 256H. In the illustrated embodiment, five heater sets 256H are provided (which circumferentially alternate with five of the mass reduction cavities 260-1M; see FIG. 9A) and corresponding generally axial flowpath portions F₁ to F₅ (although only the portions F₁ and F₂ are labeled in FIG. 8B). But a larger or smaller number of the heater sets 256H can be included in further embodiments in order to provide a larger or smaller heating capacity. In embodiments in which fewer of the heater elements 156-2 are utilized, there can be heater cavities 260-1H provided that lack a corresponding heater set 256H, or alternatively one or more of the heater cavities 260-1H can be omitted (and optionally replaced with mass reduction cavities 260-1M) and the combined housing 260-1 and/or other components of the combined motor and heater module 260 modified to accommodate a modified segment of the flowpath F through the combined motor and heater module 260. Yet, modifications to the configuration of the combined motor and heater module 260 can involve little or no modification to other modules of the pump and heater assembly 232, such that the same configurations of the pump module 250, and/or the control module 254 can be utilized with a range of different configurations of the combined motor and heater module 260. Such a modular construction means that the basic design of the pump and heater assembly 232 and certain common core sub- components can be utilized for a relatively wide variety of applications with different operating requirements for heat capacity and the like by making changes to only a limited number of sub-components (such as only to selected components of a single module).

As shown in FIGS. 9A to 10, each heater set 256H can include an electrically resistive heater clement 256-2 and a corresponding heat exchange element 256-3. In the illustrated embodiment, each heater element 256-2 can have an elongate configuration, such as in the shape of an elongate cylinder or rod, or other non-planar shape. The heat exchange elements 256-3 can be configured as sleeves, with a central cavity 256-3C, which can be closed or sealed at one end and open at an opposite end, plus primary and secondary heat transfer surfaces 256-3P and 256-3S. The primary heat transfer surface 256-3P can be a generally cylindrical surface and the secondary heat transfer surfaces 256-3S can be a plurality of fins, pins, or the like that protrude outward from the primary heat transfer surface 256-3P, in some embodiments. In the illustrated embodiment, the secondary heat transfer surfaces 256-3S are a plurality of circumferentially-spaced elongate fins that protrude radially outward (for instance, in a starburst-like pattern) with gaps in between them and extend axially over a substantial or majority of the primary heat transfer surface 256-3P at a generally middle portion thereof. Further, in the illustrated embodiment, portions 256-3P₁ and 256-3P₂ of the primary heat transfer surface 256-3P, which can be located at opposite ends of the heat exchange element 256-3, have no secondary heat transfer surfaces 256-3S. Each heater set 256H can be inserted at least partially within one of the heater cavities 260-1H. In the illustrated embodiment, each heater set 256H further extends into cavities 250-1H and 254-1H in the pump housing 250-1 and the control module housing 254-1, respectively, at opposite ends, and seals can be provided between the heater sets 256H and the cavities 250-1H and 254-1H at opposite ends of the heat exchange elements 256-3. The openings 254W_{H} can be aligned with the cavities 254-1H. The protruding secondary heat transfer surfaces 256-3S of the heat exchange elements 256-3 can rest against an interior of the corresponding heater cavity 260-1H to support the heat exchange element 256-3 and, in turn, the corresponding heater element 256-2. Electrical connections to the heater elements 256-2 can be made at the open end of the corresponding heat exchange element 256-3, with electrical connections 256-6 (e.g., wires) between the heater elements 256-2 and the circuitry 254-2 routed though the one or more openings 254W_{H}.

Turning to FIG. 8B, which includes arrows to help illustrate fluid flow (although it should be noted that fluid flow in three dimensions is somewhat more complex than what is explicitly represented by the arrows in FIG. 8B), it can be seen that in the illustrated embodiment the flowpath F enters the pump and heater assembly 232 at the inlet I, which can be arranged axially, then turns radially outward in the pump module 250 and passes to a first manifold M1. From the manifold M1, the flowpath F can then pass axially along the flowpath portions Fᵢ to Fₙ through the heater cavities 260-1H and along the corresponding heater sets 256H via a plurality of fluidically parallel paths, with the first manifold M1 distributing the coolant fluid between the heater cavities 260-1H and the corresponding heater sets 256H. The first manifold M1 can be at least partially bounded by the pump housing 250-1, the combined housing 260-1, and/or the heat exchange elements 256-3. In the illustrated embodiment, the portion 256-3P₁ of the primary heat transfer surface 256-3P faces the first manifold M1 in the radial direction, such as with a part of the portion 256-3P₁ facing an exit portion of the rotor 250-2 without any other structures radially in between them. As the coolant fluid passes through the heater cavities 260-1H and along the sets 256H, the coolant fluid is generally located outward (e.g., radially outward) and isolated from the motor 252-2 and the opening 254W_{M}. Coolant fluid (now heated) leaving the heater cavities 260-1H flows into and enters a second manifold M2, which can be located at an axially opposite side of the combined motor and heater module 260 from the first manifold M1. The second manifold M2 can be at least partially bounded by the combined housing 260-1, the control module housing 254-1, and/or the heat exchange elements 256-3. In the illustrated embodiment, the first and second manifolds M1 and M1 are located at axially opposite ends of the heater cavities 260-1H, separated by a portion of the combined housing 260-1. Moreover, in the illustrated embodiment, the portion 256-3P₂ of the primary heat transfer surface 256-3P faces the second manifold M2 in the radial direction. The coolant fluid in the second manifold M2 can flow generally (but not exclusively) circumferentially from the individual heater cavities 260-1H to the outlet O, which can be clocked so as to be circumferentially or angularly offset from the heater cavities 260-1H, in the illustrated embodiment. In the illustrated embodiment, a portion of the control module housing 254-1 that can support the bearing pilot 254-1B and can contain the opening 254W_{M} occupies a central region that urges circumferential flow in the second manifold M2. The coolant fluid can exit the pump and heater assembly 232 through the outlet O in a generally axial direction, at a location spaced from a center or middle of the assembly 232, for example. Thus, as shown in FIG. 8B, the flowpath F through the combined motor and heater module 260 in some embodiments can have a generally parallel flow arrangement, such as with multiple discrete fluidically parallel paths along the heat exchange elements 256-3 and the corresponding heater elements 256-2 that fluidically connect the first manifold M1 with the second manifold M2. The elongate configuration of the heater sets 256H allows the coolant fluid to flow along them, bounded by the wall(s) of the heater cavities 260-1H, which can be cast, drilled, milled, or otherwise formed in the combined housing 260-1 without the need to fabricate any separate tubes, plates, or the like for fluid flow. However, it should be noted that the illustrated arrangement is shown merely by way of example and not limitation, and other arrangements are possible in further embodiments, such as in embodiments with a smaller or larger number of the heater sets 256H. During operation, heat can conduct from each heater element 256-2 through the corresponding heat exchange element 256-3 to the coolant fluid present in an adjacent portion Fᵢ to Fₙ of the flowpath F.

An enclosure of the pump and heater assembly 232 can be defined by the pump housing 250-1, the control module housing 254-1 (and the cover 254-1C), and/or the combined housing 260-1.

In still further embodiments, different heater elements and associated heat exchangers in the heater section could have different configurations, for instance, such as mixing and matching configurations disclosed with respect to different embodiments discussed above. Moreover, the resistive heater elements discussed above could be used in conjunction with non-electrical heater elements or heat exchangers to further heat the coolant fluid, as desired for particular embodiments.

For any embodiment of a pump and heater assemblies 32, 132, and/or 232, heat output of the entire unit can be controlled in a variable manner. Such variable heat output can be governed by the control module 54, 154 or 254. For instance, depending on heating demand, which can be established based on sensor data, availability of heat from other sources (e.g., availability of waste heat from a traction motor or the like that can be utilized to meat total heat demand), and/or heating request signal(s) from an external controller 38, the pump and heater assembly 32, 132, or 232 can adjust the heat output of the heater module 56, 156, 260 and associated heater elements 56₁ to 56ₙ, 156-2, or 256-2 to a desired setpoint between 0-100% of the (maximum) available heat output. In one embodiment, all of the heater elements 56₁ to 56ₙ, 156-2, or 256-2 can be controlled in common, that is, all together in the same way and at the same power level. In alternate embodiments, some or all of the heater elements 56₁ to 56ₙ, 156-2, or 256-2 can be controlled differently, such as to power one or more of the heater elements 56₁ to 56ₙ, 156-2, or 256-2 less, or to turn some of the heater elements 56₁ to 56ₙ, 156-2, or 256-2 off completely, while one or more others of the heater elements 56₁ to 56ₙ, 156-2, or 256-2 are powered at relatively higher level(s). In such an alternate embodiment, total heat output of the pump and heater assembly 32, 132, or 232 at any given time is established by the sum of the different individual heat outputs of the heater elements 56₁ to 56ₙ, 156-2, or 256-2. Furthermore, variable heat output control can be continuously variable, at essentially any possible level between 0-100% of the available heat output, or alternatively at a given number of discreet heat output levels, such as at discrete high, medium, and low heat output levels.

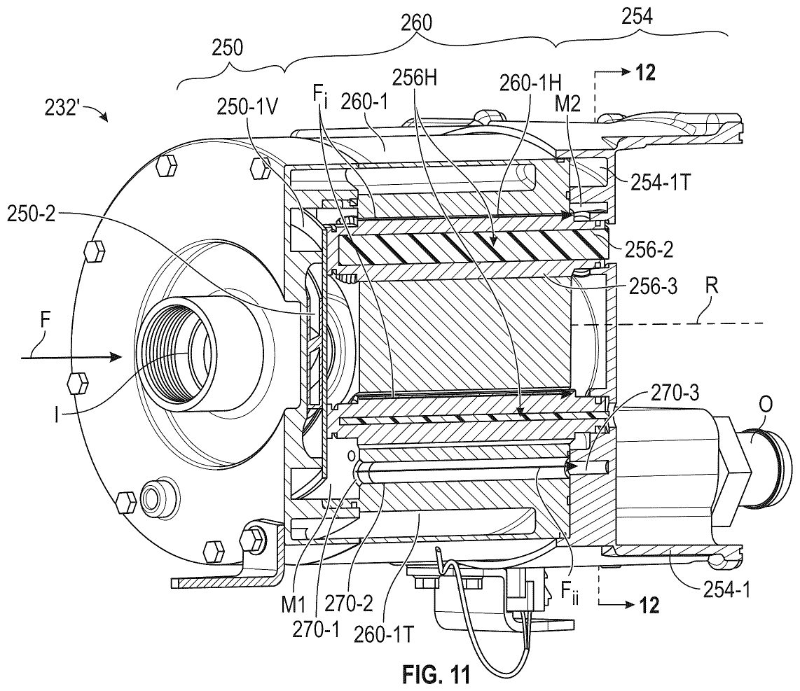

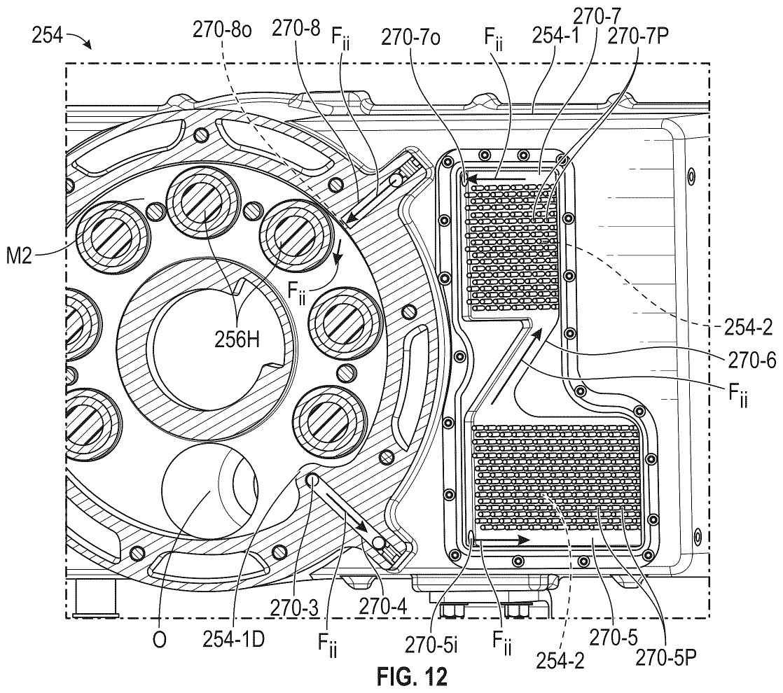

FIG. 11 is a sectional perspective view of another embodiment of a pump and heater assembly 232′, shown with portions of the control module 254 omitted for simplicity, and FIG. 12 is a sectional view taken along line 12-12 of FIG. 11. The configuration and operation of the pump and heater assembly 232′ can be generally the same as the pump and heater assembly 232 described above. However, in the illustrated embodiment of FIGS. 11 and 12, the pump and heater assembly 232′ includes a volute 250-1V that delivers coolant fluid pressurized by the rotor 250-2 to the first manifold M1 and liquid cooling of electronics of the control module 254 is further provided.

As shown in FIGS. 11 and 12, the flowpath F branches into at least a first flowpath segment Fᵢ and a second flowpath segment Fᵢᵢ, as indicated schematically in FIG. 11 by arrows. Portions of the coolant fluid in the first and second flowpath segments Fᵢ and Fᵢᵢ can have different temperatures, to provide for both internal cooling functions for electronics of the assembly 232′ and to provide pretrain heat for external delivery concurrently, while allowing flowpath segments at different temperatures to be combined before exiting the assembly 232′. The first flowpath segment Fᵢ can pass through the heater cavities 260-1H and along the heat exchangers 256-3 proximate the heater elements 256-2 to enable heating of a portion of the coolant fluid present in the first flowpath segment Fᵢ. The heater elements 256-2 can generate thermal energy through electrical resistance, and thermal energy generated by the heater elements 256-2 can be transmitted to the coolant fluid in the first flowpath segment Fᵢ by way of conduction through the corresponding heat exchangers 256-3. In the illustrated embodiment, the first flowpath segment Fᵢ includes a plurality of sub-segments that pass through a plurality of the heater cavities 260-1H that are each arranged substantially parallel to an axis of rotation R of the pump module 250 (and the rotor 150-2 thereof) and/or of the motor and heater module 260 (at the motor thereof, including its rotor).

The second flowpath segment Fᵢ can pass through a scavenge hole 270-1 to a scavenge passage 270-2. The scavenge hole 270-1 can be located in or along the first manifold M1, such as being located in the combined housing 260-1. In the illustrated embodiment, the scavenge hole 270-1 is arranged to face axially in relation to the axis of rotation R, that is, parallel to the axis of rotation R, although other orientations are possible in further embodiments. The scavenge hole 270-1 is spaced from the heater cavities 260-1H, such as being circumferentially and/or radially offset. A portion of the coolant fluid present in the first manifold enters the second flowpath segment Fᵢᵢ through the scavenge hole 270-1, while a remainder of the coolant fluid moving along the flowpath F through the first manifold M1 can pass through the first flowpath segment Fᵢ. Proportions of the coolant fluid that passes to the first and second flowpath segments Fᵢ and Fᵢᵢ can be adjusted by changing a size (e.g., diameter) of the scavenge hole 270-1, for instance. At least a portion of the scavenge passage 270-2 can extend substantially linearly and axially parallel to the heater cavities 260-1H through the combined housing 260-1, in some embodiments. The scavenge passage 270-2 can fluidically connect to a scavenge passage extension 270-3 in the housing 254-1 of the control module 154, in some embodiments. In some embodiments, a boss 254-1D can protrude into the second manifold M2 to help isolate the scavenge passage extension 270-3 and/or other portions of the second flowpath segment Fᵢᵢ from the second manifold M2 to avoid a fluidic short-circuit while still allowing various passages to be relatively closely packed together. One or more additional scavenge passage extensions 270-4 can direct the second flowpath segment Fᵢᵢ toward electronics of the control module 254, such as by changing a direction of flow of the second flowpath segment Fᵢᵢ (e.g., to move the coolant fluid in the second flowpath segment Fᵢᵢ radially outward of the heater elements 256H). Although the scavenge passage 270-2 and the scavenge passage extensions 270-3 and 270-4 can have any suitable shape to direct the portion of the coolant fluid in the second flowpath segment Fᵢᵢ along a suitable path that is separate and distinct from the first flowpath segment Fᵢ. In the illustrated embodiment, the second flowpath segment Fᵢᵢ passes along a plurality of additional scavenge passage extensions 270-4 to reach a chamber 270-5 through an inlet 270-5i.

The chamber 270-5 can be arranged proximate the electronics of the circuitry 254-2 of the control module 254. For example, in the illustrated embodiment, the housing 254-1 of the control module 254 forms an enclosure that extends away from the motor and heater module 260 (e.g., radially in relation to the axis of rotation R). The enclosure formed by the housing 254-1 contains one or more circuit boards carrying switching transistors or other electronics, which generate waste heat during operation. It is beneficial to cool electronics that may otherwise overheat. The chamber 270-5 can be a relatively flat chamber, and can have a generally rectangular perimeter in some embodiments. As shown, the chamber 270-5 is partly defined by a recess in the housing 254-1 and is closed by a cover (not shown in FIG. 12). In the illustrated embodiment, the chamber 270-5 includes an array of pin fins 2705-P. The pin fins 270-5P can extend across most but not an entire axial dimension of the chamber 270-5, in some embodiments. At least some of the pin fins 270-5P are positioned in between the inlet 270-5i and an outlet of the chamber 270-5 as an obstacle or interruption that effectively increases a length of the shortest fluid path through the cavity 270-5. The pin fins 270-5P can generate turbulence or swirl in the coolant fluid passing along the second flowpath segment Fᵢᵢ, which can help enhance convective heat transfer in addition to conductive heat transfer to improve cooling of the electronics.

In some embodiments at least one channel 270-6 can be provided that fluidically links the chamber 270-5 to a chamber 270-7 in flow series. The chamber 270-7 can include pin fins 270-7P similar to the pin fins 270-5P, and can further have an outlet 270-7o. The chamber 270-7 can be positioned proximate to another portion of the electronics of the circuitry 254-2 of the control module 254. The channel 270-6 can be arranged in a canted orientation in some embodiments, such that the channel 270-6 has a linear segment arranged without a direct or line-of-sight path between the inlet 270-5i of the chamber 270-5 and the outlet 270-7o of the chamber 270-7 (e.g., traversing both radial and circumferential distances in relation to the axis of rotation R, with the inlet 270-5i and the outlet 270-7o each being arranged at radially inward sides of the chambers 270-5 and 270-7). Such an arrangement helps increase a length of the second flowpath segment Fᵢᵢ and can promote enhanced cooling.

In the illustrated embodiment, each of the chambers 270-5 and 270-7 (and also the second manifold M2), with that common plane arranged substantially perpendicular to the axis of rotation R. Such a configuration helps to space the electronics away from the heater elements 256H, to reduce a risk of unwanted heating of the electronics by the heater elements 256H, while still providing a relatively compact over all assembly unit. However, other arrangements are possible in further embodiments, such as where electronics are present in other locations. Moreover, in various embodiments, greater or smaller numbers of chambers can be provided, and one or more such chambers can be arranged fluidically in parallel rather than in flow series in alternate embodiments.

The coolant fluid exiting the chamber 270-7 through the outlet 270-7o can pass through an outlet channel 270-8 with an outlet 270-8o (for example, a generally radially oriented outlet 270-8o) that delivers the coolant fluid to the second manifold M2. A size (e.g., diameter) of the outlet 270-7o and/or the outlet channel 270-8 can be selected to reduce a chance of backflow from the second manifold M2. In the illustrated embodiment, the outlet channel 270-8 is circumferentially spaced from both the outlet O and the boss 254-1D, and extends radially inward, although other arrangements are possible in further embodiments. By circumferentially spacing the outlet channel 270-8 from the outlet O, mixing of the coolant fluid from the first and second flowpath segments Fᵢ and Fᵢᵢ is promoted, to provide a relatively homogenous temperature to quantities of the coolant fluid in the flowpath F when exiting the pump and heater assembly 232′ through the outlet O.

During operation, the coolant fluid passing along the flowpath F enters the pump and heater assembly 232′ and is propelled and pressurized by the rotor 250-2 (e.g., impeller) of the pump module 150, then passes to the volute 250-1V and is dispersed into the first manifold M1 that is fluidically downstream. The flowpath F branches at the first manifold M1 into fluidically parallel heating and cooling segments. The first flowpath segment Fᵢ is a heating segment, in which a relatively large portion of the coolant fluid is directed in close proximity to one or more of the heater elements 256-2, which heat the passing coolant fluid. The heated (and pressurized) coolant fluid in the first flowpath segment Fᵢ is then passed downstream to the second manifold M2. In order to cool at least a portion of the electronics that are part of the circuitry 254-2 of the control module 254, particularly the switching transistors (e.g., IGBTs or SiC MOSFETS), another scavenged portion of the coolant fluid passes in close proximity to those electronics along the second flowpath segment Fᵢᵢ, which flow fluidically parallel to the first flowpath segment Fᵢ and bypasses the heater elements 256-2. After absorbing waste heat from the electronics, the coolant fluid passing through the second flowpath segment Fᵢᵢ then passes downstream to the second manifold M2, where the coolant fluid from the first and second flowpath segments Fᵢ and Fᵢᵢ is combined and mixed, prior to the flowpath F exiting the pump and heater assembly 232′ through the outlet O. In some embodiments, the second flowpath segment Fᵢᵢ can extend through or within various housings (e.g., 260-1 and 254-1) of the pump and heater assembly 232′, without any hoses exposed externally. The first and second flowpath segments Fᵢ and Fᵢᵢ can each have complex shapes (for instance, the second flowpath segment Fᵢᵢ can traverse radial axial and circumferential distances through portions of the combined motor and heater module 260 and the control module 254) and can be fluidically separate from each other in between the first and second manifolds M1 and M2.

Control functions for embodiments of a pump and heater assembly can include the following aspects, in some embodiments. Both a motor module for a pump and a heater module can be controlled with a common microcontroller, although in other embodiments multiple microcontrollers can be utilized. In some embodiments, temperatures of heater elements can be limited as a function of pump motor speed, such that the heater elements do not turn on unless the pump is operating (or operating at a sufficient speed), which can help avoid undesired boiling of a liquid coolant fluid. For example, D curve breakers can be utilized in connection with protection circuitry to limit heater element energization as a function of pump motor speed. Other heater control methods can handle or compensate for faults. For instance, if there is a short circuit all heater elements can be turned off but if a given heater element fails open (creating an open circuit) then one or more other heater elements can still operate, and it is further possible to adjust operation of other heaters to compensate for one or more heaters being non-operational in terms of overall heat output. Moreover, if there is a fault, a user can be notified, such by issuing an alert or signal that maintenance is required.

Methods of making and using embodiments of a pump and heater assembly according to the present invention will be apparent to persons of ordinary skill in the art from the entirety of the present disclosure, including the accompanying figures. Moreover, numerous advantages and benefits associated with the disclosed invention will be appreciated. For example, disclosed embodiments of the present invention provide a high voltage electric pump and heater assembly that is highly modular in construction to allow flexibility in terms of heating capacity while still allowing the use of the same or highly similar core components. A relatively compact and relatively low mass overall package is also provided in disclosed embodiments. Moreover, electrical connections, such as wired connections, can be fabricated relatively easily, without creating interference between the routing of electrical and fluidic lines that must be isolated to prevent short circuits and/or leaks. In some embodiments, fabrication and assembly of pump and heater assemblies can be done modularly, allowing different heater modules (including different combined motor and heater modules) to be utilized with similar or identical core components, and assembly can involve a generally axial stack-up of modules that makes assembly relatively easy, such as making is relatively easy to complete internal electrical connections and/or fluidic connections within or between modules. Additionally, relatively rugged and robust structures and connections can be provided to accommodate the sometimes-extreme conditions that may be experienced by the pump and heater assembly when used in vehicular applications. Furthermore, a scavenge path can be provided that allows integrated or on-board electronics of the pump and heater assembly to be cooled using the same fluid used for heating, with branched flowpath segments allowing for fluid flows through the assembly to be at different temperatures to provide cooling for internal components and heating for external use concurrently.

Any relative terms or terms of degree used herein, such as “substantially”, “essentially”, “generally”, “approximately”, and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, transient alignment or shape variations induced by thermal, rotational or vibrational operational conditions, transitory signal or power fluctuations, and the like. Moreover, any relative terms or terms of degree used herein should be interpreted to encompass a range that expressly includes the designated quality, characteristic, parameter, or value, without variation, as if no qualifying relative term or term of degree were utilized in the given disclosure or recitation.

The word “comprise”, or variations such as “comprises” or “comprising” are used in an open-ended manner herein and should be interpreted to refer to the inclusion of a stated element, feature, or step, or group of elements, features, or steps, but not the exclusion of any other element, feature, or step, or group of elements, features, or steps. Unless further expressly qualified, use of the word “comprise” or variations thereof does not, alone, exclude the present additional, unrecited elements, steps, or groups of elements or steps. Additionally, unless further expressly qualified, the words “a” and “an” as used herein refer to one or more and do not limit the identified element, feature, step, or the like to one and only one. However, use of the words “a” and “an” herein should be interpreted in accordance with and subject to any applicable further limits expressly stated in the context of any particular instance of usage, without extending such context-specific limits to all other uses generally.

Although the present invention has been described with reference to preferred embodiments, workers skilled in the art will recognize that changes may be made in form and detail without departing from the spirit and scope of the invention. For instance, FIG. 4, FIGS. 5A to 7B, and FIGS. 8A to 10 each illustrate an embodiment of a pump and heater assembly. In general, persons of ordinary skill in the art will appreciate that components, configurations, and functionality described with respect to one embodiment can generally be utilized with another disclosed embodiment unless otherwise explicitly indicated to the contrary. Moreover, some embodiments can include the same or similar pump, motor, and control module components but can have different configurations of a heater section, for instance, such as with a spiral or helical flow path along or between heater elements. Moreover, in further embodiments, manifolds (when utilized) could be formed or defined entirely by one or more heat exchange elements, an exterior housing component, a dedicated manifold structure, or the like.

1. A pump and heater assembly, comprising:
an electric motor;
a pump operatively connected to the electric motor;
one or more heater elements each configured to generate heat through electrical resistance;
a plurality of heat exchange elements each having a primary heat transfer surface and secondary heat transfer surfaces that project from the corresponding primary heat transfer surface, wherein at least one of the heat exchange elements is provided adjacent to each of the heater elements;
a control module that includes electronics, wherein the control module is electrically connected to the electric motor and to the heater elements; and
a flowpath through which a coolant fluid is flowable, the flowpath fluidically passing from an inlet to the pump, to a first manifold downstream of the pump, to a second manifold downstream of the first manifold, and to an outlet downstream of the second manifold, wherein the flowpath includes:
a first flowpath segment that passes along at least one of the heat exchange elements to permit heat transfer therebetween, such that at least a portion of the coolant fluid present in the first flowpath segment is can be heated; and
a second flowpath segment that passes in close proximity to at least a portion of the electronics of the control module to permit heat transfer therebetween, such that at least the portion of the electronics of the control module are coolable by transferring heat to a portion of the coolant fluid present in the second flowpath segment.

2. The pump and heater assembly of claim 1, wherein the electronics include switching transistors.

3. The pump and heater assembly of claim 2, wherein the electric motor is configured as a permanent magnet brushless DC motor.

4. The pump and heater assembly of claim 1, wherein the heater elements are configured as rods, wherein the heat exchange elements are each configured as a sleeve with a central cavity, and wherein each of the heater elements is at least partially positioned within the central cavity of a corresponding one of the heat exchange elements.

5. The pump and heater assembly of claim 1, wherein the secondary heat transfer surfaces are configured as a plurality of circumferentially-spaced, elongate fins that protrude radially outward.

6. The pump and heater assembly of claim 1 and further comprising:
a housing with a plurality of heater cavities, wherein one of the heater elements is at least partially positioned within a first one of the heater cavities, and wherein a second one of the heater cavities lacks any heater element.

7. The pump and heater assembly of claim 1, wherein the flowpath further includes:
a first manifold located downstream of the pump; and
a second manifold located downstream of the first manifold, wherein the first flowpath segment and the second flowpath segment are fluidically connected between the first manifold and the second manifold in parallel.

8. The pump and heater assembly of claim 7 and further comprising:
a scavenge hole located in or along the first manifold, wherein the scavenge hole directs a portion of the coolant fluid into the second flowpath segment and a remainder of the coolant fluid passes to the first flowpath segment.

9. The pump and heater assembly of claim 8, wherein the scavenge hole is arranged parallel to an axis of rotation of the pump, wherein a first of the heater elements and a first of the plurality of heat exchange elements are positioned at least partially within a heater cavity that extends parallel to the axis of rotation of the pump, and wherein at least a portion of the first flowpath segment passes through the heater cavity.

10. The pump and heater assembly of claim 1 and further comprising:
a first chamber containing a plurality of pin fins, wherein the first chamber is located proximate the portion of the electronics of the control module to permit heat transfer from the portion of the electronics to the portion of the coolant fluid present in the second flowpath segment through conductive heat transfer through material of a housing of the control module, and wherein the second flowpath segment passes through the first chamber.

11. The pump and heater assembly of claim 10 and further comprising:
a second chamber containing a plurality of pin fins, wherein the second chamber is located proximate an additional portion of the electronics of the control, and wherein the second flowpath segment passes through the second chamber; and
a channel fluidically connecting the first chamber and the second chamber.

12. The pump and heater assembly of claim 10, wherein the first chamber and the second manifold overlap a common plane arrange substantially perpendicular to an axis of rotation of the pump.

13. A vehicle comprising:
the pump and heater assembly of claim 1;
an on-board electric power source electrically connected to the pump and heater assembly;
a liquid-to-air heat exchanger; and
a fluid circuit fluidically connecting the heat exchanger and the pump and heater assembly.

14. A method of electrically heating and pumping a coolant fluid, the method comprising:
providing electric power to a motor and to a plurality of heater elements using a shared control module that includes electronics;
operating the motor to drive a pump;
pressurizing the coolant fluid with the pump;
distributing a first portion of the pressurized coolant fluid to a first flowpath segment and a second portion of the pressurized coolant fluid to a second flowpath segment;
passing the first portion of the pressurized coolant fluid in the first flowpath segment along a plurality of heat exchange elements, wherein each of the plurality of heat exchange elements is located adjacent to at least one of the heater elements;
generating thermal energy with at least one of the heater elements;
heating the first portion of the pressurized coolant fluid through conductive transfer of at least some of the thermal energy generated with the heater elements to the first portion of the pressurized coolant fluid through at least some of the plurality of heat exchange elements;
passing the second portion of the pressurized coolant fluid in the second flowpath segment near at least a portion of the electronics of the control module to provide cooling, such that waste heat from at least the portion of the electronics is transferred to the second portion of the pressurized coolant fluid; and
moving the first portion of the pressurized coolant fluid coolant fluid and the second portion of the pressurized coolant fluid through an outlet bore to exit the pump and heater assembly.

15. The method of claim 14, wherein the step of providing electric power to the motor and to the plurality of heater elements using the shared control module that includes the electronics comprises providing operational high voltage electrical power at 400-1200 V DC.

16. The method of claim 14, wherein the first and second flowpath segments are fluidically arranged in parallel.

17. The method of claim 16 and further comprising:
combining the first portion of the pressurized coolant fluid and the second portion of the pressurized coolant fluid in a manifold located upstream of the outlet bore.

18. The method of claim 17, wherein the pressurized coolant fluid in the first and second flowpath segments are at different temperatures when arriving at the manifold.

19. The method of claim 14 and further comprising:
controlling operation of the motor utilizing switching transistors that comprise at least the portion the electronics of the control module.

20. A pump and heater assembly, comprising:
an electric motor;
a pump operatively connected to the electric motor;
one or more heater elements each configured to generate heat through electrical resistance;
a control module electrically connected to the electric motor and to the heater elements, wherein the control module includes switching electronics usable to control operation of the electric motor; and
a flowpath through which a coolant fluid is flowable, the flowpath fluidically passing to a first manifold downstream of the pump, to both first and second flowpath segments branching from the first manifold, and to a second manifold downstream of both the first and second flowpath segments, wherein the first flowpath segment passes proximate to the heater elements to enable heating of a portion of the coolant fluid present in the first flowpath segment, wherein the second flowpath segment passes through the control module proximate to the switching electronics to enable cooling of the switching electronics by a portion of the coolant fluid present in the second flowpath segment, wherein the first and second flowpath segments are arranged fluidically in parallel.

21. The pump and heater assembly of claim 20, wherein a first of the heater elements is positioned at least partially within a heater cavity that extends parallel to an axis of rotation of the pump, wherein at least a portion of the first flowpath segment passes through the heater cavity, and wherein a scavenge hole is arranged parallel to an axis of rotation of the pump in or along the first manifold to direct a portion of the coolant fluid into the second flowpath segment.

22. The pump and heater assembly of claim 20 and further comprising:
a chamber containing a plurality of pin fins, wherein the chamber is located proximate the portion of the electronics of the control module to permit heat transfer from the portion of the electronics to the portion of the coolant fluid present in the second flowpath segment through conductive heat transfer through material of a housing of the control module, and wherein the second flowpath segment passes through the chamber.

23. The pump and heater assembly of claim 22, wherein the chamber and the second manifold overlap a common plane arrange substantially perpendicular to an axis of rotation of the pump.
